(19) United States
(12) Patent Application Publication
(10) Pub. No.: US 2009/0141586 A1
(43) Pub. Date: Jun. 4, 2009

(54) Mixing apparatus

(76) Inventor: Lester Robert Dyer, III, New Orleans, LA (US)

Correspondence Address: MICHAEL D. CARBO, 1220 PINE STREET, NEW ORLEANS, LA, 70118, US

(21) Appl. No.: 11/998,904

(22) Filed: Dec. 3, 2007

(51) Int. Cl. B01F 13/00

(52) U.S. Cl. 366/343

(57) ABSTRACT

The mixing rod having attached blades, the blades being of the propeller type or the impeller type, including propellers or impellers that are elongated flat-plate, curved, or contoured. The blades have arched projections extending upward or downward, or both. The arched projections are formed so that material to be blended or mixed can flow through the arch, that is, under the arch, when the blades are rotated. The blades optionally have apertures or holes therethrough, which apertures or holes, when present, are under or otherwise adjacent to the arched projections.

### CROSS-REFERENCE TO RELATED APPLICATIONS

None

### BACKGROUND OF THE INVENTION

1. Field of the Invention

The present invention relates to power mixer devices of the revolving blade type for use in blending and mixing powders and fluids, such as drywall mud, to achieve homogeneous mixtures, and for use in mixing viscous fluids, such as paint and the like, and more particularly to a mixing bit of novel blade construction for mixing materials and viscous fluids into a homogeneous condition.

2. Description of Related Art

Mixing devices having blades are disclosed in the art. For example, U.S. Pat. No. 579,668 to Wilson discloses a churn dasher having coaxial rotary blades provided with radial wings deflected respectively in opposite directions to cause rotation in opposite directions, each wing being provided with openings and with contiguous ears arranged approximately perpendicular to the plane of the wing, the ears of the upper blade extending upwardly and of the lower blade downwardly. The ears are struck from the blades.

U.S. Pat. No. 2,736,537 to Nelsson discloses a mixing bit having upper and lower mixing members adjacent the lower end of a vertical shaft, each member comprising a plurality of propeller blades spaced equiangularly about and extending radially from the shaft and angularly disposed at an angle with respect to a plane extending at right angles to the shaft. The pitch of the upper blades is such as to cause downward displacement of mixed fluid, while the pitch of the lower blades is such as to cause upward displacement of mixed fluid.

U.S. Pat. No. 3,222,038 to Ashcraft discloses a mixing apparatus having disc plates, the disc plates having apertures and having inclined radial vanes canted toward the direction of rotation of the discs.

U.S. Pat. No. 3,630,636 to Hill discloses mixer blades with a first mixer blade having slots and associated arrays of oppositely directed slot deflectors.

U.S. Pat. No. 5,090,816 to Socha discloses a rotatable impeller having a multiplicity of blades, each blade having an elliptical flow-through aperture. Socha also discloses identical spaced-apart impellers.

U.S. Pat. No. 4,083,653 to Stiffler discloses a shaft-mounted hub having five axially nested, radially extendable fins, vanes, or blades, each fin being provided with holes therethrough.

The present invention has a combination of features that are not found in the disclosed art. The arched projections of the present invention that allow for flow through the arch are not disclosed in the above described art. Further, the combination of arched projections and associated holes are not disclosed in the above described art.

### BRIEF SUMMARY OF THE INVENTION

The invention pertains to mixing apparatus for stirring and blending fluids. The mixing rod has attached blades. The blades of the invention are of the propeller type or the impeller type, which are used as equivalents herein. The blades can be elongated flat plates or, preferably, propeller-type blades. The blades have arched projections extending upward or downward, or both. The arched projections are formed so that material to be blended or mixed can flow through the arch, that is, under the arch.

The blades optionally have apertures or holes therethrough, which apertures or holes, when present, are under or otherwise adjacent to the arched projections.

### BRIEF DESCRIPTION OF THE SEVERAL VIEWS OF THE DRAWING

FIG. 1 is a slightly perspective side view of the mixing apparatus according to an embodiment of the invention.

FIG. 2 is a side view of a mixing apparatus, showing two sets of blades, according to an alternative embodiment of the invention.

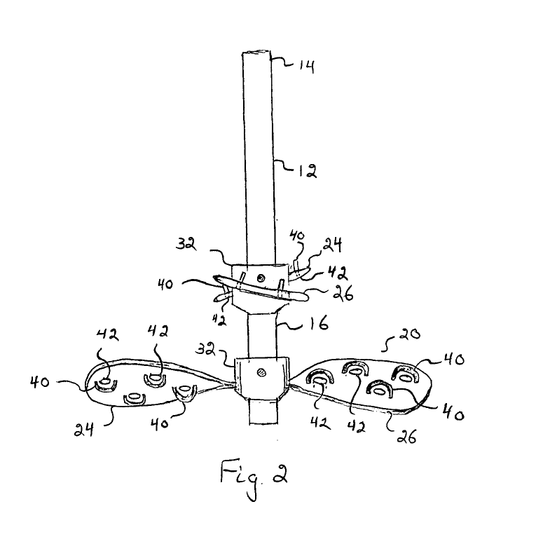

### DESCRIPTION OF AN ILLUSTRATIVE EMBODIMENT

For promoting an understanding of the principles of the invention, reference will now be made to the embodiment illustrated in the several views of the drawing and specific language will be used to describe the invention. For brevity, like elements and components will be given the same designation throughout the figures. It will nevertheless be understood that no limitation of the scope of the invention is thereby intended, such alterations and further modifications in the illustrated device and such further application of the principles of the invention as illustrated therein being contemplated as would normally occur to one skilled in the art to which the invention relates.

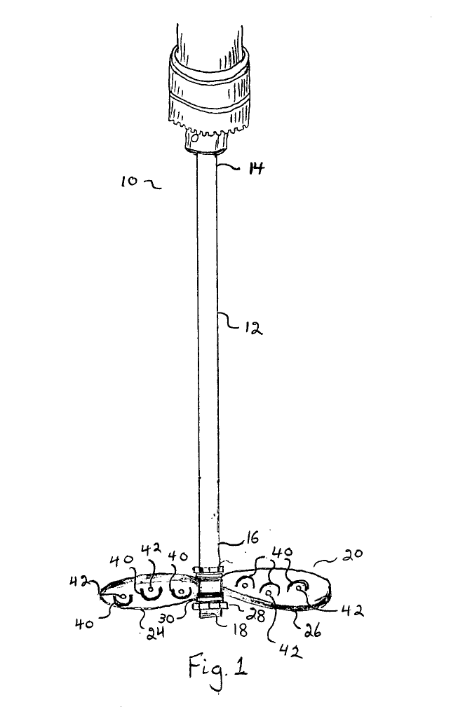

Referring to FIG. 1, an embodiment of a mixing apparatus or device 10 according to the invention is illustrated. The device comprises a shaft 12, sometimes referred to as rod 12. Shaft 12 is rotatably driven by a conventional drill (not shown) or similar motorized power source at an upper end 14 thereof. A lower end 16 of shaft 12 has threads 18 to receive propellers or propeller blades having apertures therein. Attached to lower end 16 of shaft 12 is a mixing propeller 20. Propeller 20 as illustratively shown is a single plate that has a circular central aperture and curved outer ends. Propeller 20 is attached to lower end 16 of shaft 12 by screwing propeller 20 onto threads 18 on lower end 16 of shaft 12. Propeller 20 can be held in place on shaft 12 by conventional means that can include nuts 28 and lock washers 30. Propeller 20, when affixed to shaft 12, forms oppositely extending blade portions 24 and 26 that extend outward along an axis that is perpendicular to shaft 12. Preferably, two propellers 20 are affixed to shaft 12 in a spaced-apart arrangement along shaft 12.

Each outwardly extending blade portion 24 or 26 can be angled into the flow stream at a, preferably small, angle of attack. Alternatively or in addition, each radially extending blade portion 24 or 26 can be curved or contoured, or both, to reduce turbulence during mixing. When two spaced-apart propellers are employed, the direction of curvature and the specific contouring can be chosen to force the mixture (i) downward, (ii) upward, (iii) between the propellers, or (iv) upward from the top propeller and downward from the bottom propeller.

Alternatively, propeller 20 can comprise two or more blades projecting in a balanced array from shaft 12 at lower end 16. In this alternative arrangement, the blades can be integrally formed to extend or project radially outward on a hub section that has a borehole for receiving lower end 16 of shaft 12 in a fixed engagement. In the further alternative, the blades can have apertures at or near an end thereof and can thereby be affixed to lower end 16 of shaft 12 by screwing each blade onto threads on lower end 16 of shaft 12 or by other methods of affixation. The blades can be held in place on shaft 12 by conventional means that can include nuts 28 and lock washers 30.

A plurality of arched projections 40 are disposed on an upper surface, a lower surface, or both, of each of the blade portions 24 and 26. Arched projections 40 are disposed to project outwardly from at least one surface of blade portions 24 and 26. The contour of arched projections 40 can be semicircular, elongated in the projecting direction, or elongated in the direction radially outward from shaft 12. Optionally, the blades have holes 42 formed therethrough.

Cutting or otherwise forming slits through a blade and stretching the blade material that is between the slits upward or downward to form an arch can form arched projections 40 and residual holes 42. The length of the slits is variable depending on the thickness and malleability or stretchability of the blade material. The contour of an arch can be semicircular, elongated in the projecting direction, or elongated in the direction radially outward from shaft 12. In the further alternative, an S-shaped arch can be formed with one hump projecting, upward for example, from one surface of a blade portion and the other hump projecting, downward for example, from an opposite surface of the blade portion.

Yet another alternative for forming arched projections 40 is to cut or form a hole through a blade portion 24 or 26, or both, cut or form nested curved slits adjacent to the hole, and then bend the blade portion material between two slits upward or downward to form an arch of material over the hole. The bend can be such that the arch is perpendicular to the surface of the blade portion, or, alternatively, the bend can be such that the arch is inclined, either in the direction of motion of the blades or away from the direction of motion of the blades. When the arches are inclined with respect to the surface of the blades, the blades can optionally be not angled in the direction of motion, not contoured, or both.

A purpose of the plurality of arched projections 40 is to cause the projecting arches to break up small lumps in a mixture. When drywall mud, for example, is prepared for use, water is usually added slowly to a container containing dry powdered drywall material and the combination is mixed. When a coating of wetted material surrounds small aggregations of dry material, lumps of material form. Although the blade edges in the direction of circular motion act to break up lumps, using arched projections 40 increases the effective length of lump-breaking edges, resulting in an improved mixing action and more efficient mixing. The edges of arched projections 40 can be thinner and sharper than relatively blunt edges of blade portions 24 and 26, to allow safe handling of the blade portions at their edges while achieving more effective lump breaking with the device.

Additionally, arched projections can be formed by affixing material to blade portions 24 and 26, either in addition to or in lieu of slitting or cutting the blade material. These added arched projections are optionally used with holes through the blades as described above.

While an illustrative embodiment of the invention has been illustrated in the several views of the drawing and described in detail in the foregoing description, it is understood that only an illustrative embodiment has been shown and described and that changes and modifications can be made without departing from the scope of the invention as particularly pointed out in the following claims.

What is claimed is:

1. A mixing rod comprising:
an elongated rigid shaft having an upper end portion adapted for attachment to a means for rotating the shaft, and having a lower end portion adapted for receiving, in fixed engagement, at least one blade,
the at least one blade comprising an elongated plate having a central aperture adapted for engagement onto the lower end portion of the shaft, the at least one blade being affixed to the shaft to form oppositely extending blade portions that extend outwardly along an axis that is perpendicular to the shaft, and
a plurality of arched segments disposed on and projecting outwardly from a surface of the at least one blade.

2. The mixing rod according to claim 1, wherein the at least one blade has holes therethrough and wherein at least some of the plurality of outwardly projecting arched segments are disposed adjacent to the holes.

3. The mixing rod according to claim 1, wherein the arched segments are formed from material comprising a portion of the at least one blade.

4. The mixing rod according to claim 1, wherein the at least one blade is contoured to reduce turbulence.

5. The mixing rod according to claim 1, wherein the at least one blade is angled upward or downward with respect to the direction of rotation of the shaft.

6. The mixing rod according to claim 1, wherein the at least one blade comprises at least two blades, each of the at least two blades being spaced apart longitudinally along the shaft from another of the at least two blades.

7. The mixing rod according to claim 6, wherein one of the at least two blades is angled or contoured to induce an upward movement of a portion of a mixture during rotation of the shaft and another of the at least two blades is angled or contoured to induce a downward movement of another portion of the mixture during the rotation of the shaft.

8. The mixing rod according to claim 1, wherein some of the plurality of outwardly projecting arched segments are perpendicular to the surface of the at least one blade.

9. The mixing rod according to claim 1, wherein some of the plurality of outwardly projecting arched segments are not perpendicular to the surface of the at least one blade.

10. A mixing rod according to claim 1, wherein the at least one blade has holes therethrough and wherein some of the plurality of outwardly projecting arched segments are disposed adjacent to the holes.

11. The mixing rod according to claim 6, wherein the at least two blades are disposed in a balanced array with respect to each other so that the shaft is substantially balanced during a rotation of the shaft and consequent spinning of the blades.
